(19) United States
(12) Patent Application Publication
(10) Pub. No.: US 2007/0189883 A1
(43) Pub. Date: Aug. 16, 2007

(54) Lifting auxiliary

(75) Inventors: Wilhelm Maurer, Unterengstringen (CH); Andreas Maurer, Zurich (CH); Peter Mauer, Chur (CH); Eveline Blabol, Buchs (CH); Pascal Mosetti, Niederlenz (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: M&F INGENIEUR BERATUNGS AG, Zurich (CH)

(21) Appl. No.: 10/568,061

(22) PCT Filed: Aug. 2, 2004
(86) PCT No.: PCT/CH04/00483

§ 371 Date: Nov. 20, 2006

(30) Foreign Application Priority Data
Aug. 14, 2003 (EP) 03018479.0

(51) Int. Cl. B65G 67/00

(52) U.S. Cl. 414/373

(57) ABSTRACT

An arrangement for ascending and/or descending one or several persons along a high object, for example a high-tension line tower, a cable railway tower, high building etc., which arrangement is provided with a longitudinally extended rail profile and at least one guide component extending along the profile and a component for receiving a power transmission oriented towards the profile and/or the guide component. A lifting auxiliary is provided with at least one lifting support comprising at least one platform or a seat, a safety catch for persons and/or a handle, at least one force transmitting element connected or applied to the guide component and/or the profile and/or a drive and one organ carrying the element or the drive on or in at least the guide component and/or the profile.

This invention relates to an arrangement or climbing aid for the ascent and/or descent of at least one person according to the preamble of claim 1.

Wherever great heights must be negotiated, as on smokestacks, tall buildings, silos, cableway masts, transmitting antennas, wind turbines, high-voltage poles, cranes and the like, ladders are generally fixedly mounted so that, for example, maintenance and repair work can be preformed at any time. For electric power supply in Germany alone, for example, well over one million high-voltage poles are in use, which are often provided with fixed ladders.

Accident statistics for ladders and steps in Germany reflect an annual count of approximately 40,000 accidents involving falls, 40 of them with fatal consequences. Ascending and descending ladders is dangerous; thus, a study by the Technical College of Darmstadt showed that approximately 70% of accidents connected with ladders occurred on fixed ladders, users often having fallen. There are many distinct types of ladders functioning chiefly by the rung principle. In ascending and descending, the user must feel with hands and feet from one rung to the next-stepping or gripping off to the side is thus always possible.

In DE-102 01 965 an apparatus for traveling vertically upwardly directed paths is proposed. What is disclosed there is a climbing aid actuatable by muscular force, which is movable upwardly or downwardly in crawler fashion on a stationarily attached ladder. Arranged on the crawlers are gripper elements, which are each able to engage into the rungs of the ladder. If, however, these gripper elements are arranged not exactly analogously to the rung spacings, there is either the danger of blocking of the ascending motion or, however, an abrupt downward motion takes place after every engagement of a gripper into a rung. Because of the construction described, the proposed apparatus is really not well-suited to make a contribution to the problem referred to at the outset.

It is now a goal of the present invention to propose a climbing aid, in particular for negotiating great heights, in which the danger of falling is much reduced, ascent and descent are simplified, and are less strenuous and thus more efficient in terms of work expended because usage is ergonomically correct.

According to the invention, the stated goal is achieved with an arrangement according to the language of Claim 1.

The proposed arrangement or system essentially comprises two elements—a rail-like, longitudinally extended profile, and the climbing aid proper. The longitudinally extended rail-like profile is the simplest possible profile, which can preferably be fixedly fastened to an object to be climbed, as for example a high-voltage pole, a cableway mast, etc. The profile has guide elements, such as at least one guide component extending longitudinally along the profile, suitable for holding and guiding the climbing aid, as well as a component suitable for transmitting force or accepting the transmission of force from the at least one climbing aid. According to one embodiment, the force-transmitting component or, as appropriate, the guide component can have longitudinal elements, for example in the form of a rack or grid.

The climbing aid comprises at least one, preferably two, climbing consoles made up of at least a platform as well as at least one personal safety device and/or a handle and at least one force-transmitting element engaging into or onto the guide component and/or the force-transmitting component of the longitudinal profile, as well as a retaining or securing device for holding and/or guiding the climbing console or consoles on the rail-like profile. In the case where the force-transmitting component and/or the longitudinal guide component on the profile is fashioned in rack or grid form, the force-transmitting element is for example a pivotable or rotatable element engaging in the component of rack or grid form. Further, there is a holding device in order to hold the force-transmitting element in or on the guide component of the profile.

The climbing aid can be fashioned in one piece, two pieces, or a plurality of pieces and, according to a preferred embodiment, has a right climbing console and a left climbing console, which are constructed identically but in mirror-image fashion. The left console and the right console each comprise a footrest and a handle. The footrest is made for example as a small platform having, as appropriate, one strap each, for example to lift the console in climbing. The foot stands -on the platform and is, as appropriate, kept in place from above with the strap.

In ascending, one simultaneously raises the right hand and the right foot by an individually desired increment or step height. While being lifted, the right console of the climbing aid slides and/or rolls upward with the least possible resistance. Now one loads the left side and raises the left arm and foot, so that the left console of the climbing aid slides and/or rolls upward. In this way one can climb upward alternately on the left side and the right side and while doing so one is always firmly connected to the rail-like profile via the climbing aid.

For additional protection, the user has the ability to secure himself to the climbing aid using a safety belt or harness. The position of the climbing aid or of the two consoles relative to the rail-like profile is determined by the guide component or components on the profile and/or the force-transmitting component or components, as for example the rack or gridwork, by accommodation of force on the rail-like profile and by the force-transmitting elements, such as for example the pinion or pinions, on the console or consoles. In ascending, for example, the pinion automatically runs along without resistance via a free-wheeling hub. The pinion is connected for example to an electric motor or a rotary dashpot or similar drive, which in ascending runs along without resistance because of the free-wheeling hub. In descending, the drive or rotary dashpot can be rotated only by the preset torque. In this way, descent is possible only at the predetermined speed. Along with the dashpot there is also a brake in the pinion of each console, the brake as a rule being always engaged and thus operating automatically, no action being performed in ascending motion, however, because of the free-wheeling hub provided. If the user wishes to descend, he releases the brake and the climbing aid or the two consoles automatically slide downward, preferably controlled at the specified speed by the co-running drive or dashpot. In descending, the brakes of both consoles of the climbing aid are released simultaneously and one slides downward as long as the brakes are released. If a dashpot fails, safety is still ensured by the other elements, such as brakes and dashpots, of the same and/or the other console. The same applies if a brake fails. The safety of the climbing aid or the two consoles is thus always twofold per side and thus at least fourfold in the system or arrangement.

According to a further embodiment of the arrangement or climbing aid proposed according to the invention, the force-transmitting elements are connected to drive motors, such as for example battery-powered electric motors or linear motors, which act in reinforcing fashion in ascent by, for example, lifting the dead weight of the climbing aid. If for example the right side the climbing aid is unloaded by lifting the foot, this side of the climbing aid slides upward without much resistance and with additional reinforcement by the drive motor. Next the right side is loaded and the left side is unloaded by lifting the left foot, so that this side again automatically slides upward with reinforcement by a further drive motor. If pinions are used, for example, these are each connected to one or a plurality of electric motors, battery-powered for example, which automatically lift the dead weight of the climbing aid in ascending. It is of course possible to select the drive such that more or less the dead weight of the climbing aid is driven upward by the drive motors. The drive can be fashioned such that the climbing aid or the two consoles are operable in the manner of a lift and thus the person using the lift need not provide any actuation at all. Finally, it should be stated for the sake of completeness that if for example linear motors are employed, the use of pinions can be dispensed with altogether by transmitting the drive in contactless fashion from the motor to the guide elements or the force-transmitting elements.

Again, according to a further embodiment, it is possible that the drive motors referred to are used as generators in descending, which generators can turn for example at a preset speed. In this way, on the one hand, descent at a predetermined speed is ensured, and along with the drive motors there are also, as already stated, additional braking systems on each side.

The rail-like profile is preferably fashioned in a plurality of pieces capable of being joined together and fixedly attached to a mast, profiles capable of being stood loose against an object naturally being possible as well. In the case of a profile fashioned in a plurality of pieces it is conceivable that a longitudinal expansion or contraction of the profiles can occur at a transition region from one profile to the next, which can be accommodated for example by the insertion of connectors of variable length. These connectors can for example be elastic in the longitudinal direction or, however, can have guide elements mechanically engaging in one another, which guide elements permit a longitudinal expansion or contraction of the connecting element. This can be useful for example if there are wide temperature fluctuations on the object on which ascent or descent is performed, as for example on a high-voltage pole where temperature differences between −20° C. and +60° C. are entirely possible under intense sunlight. The rail-like profile has the guide components mentioned, in or on which the climbing aid or the two consoles are supported and ascent or descent is made possible for example via the force-transmitting elements mentioned, such as for example the pinions. The profile is preferably designed such that it can be fabricated as a simple extruded profile without much finishing work. Through the use of a simple rack-like profile or a grid profile as the force-transmitting component, the arrangement or system according to the invention can even be fabricated more inexpensively than ladders. The most important advantages of the arrangement or climbing aid mentioned are that the safety is much greater than in comparable systems such as ladders; the ergonomically improved mode of operation for the user; the saving of time in ascending and/or descending; and the saving of investment and operating costs. A further advantage is that the arrangement according to the invention cannot be climbed without the use of the climbing aid. Thus, in the case of high-voltage poles for example, the rail-like profile alone cannot be climbed by unauthorized persons. What is more, climbing by unauthorized persons is not possible if a service assembler working on a high-voltage pole is active in the top section of the pole.

When the climbing aid proposed according to the invention is employed as a lift, it is also possible to transport materials or to transport, for example, injured persons. In this respect it can also be advantageous to affix a rail-like profile to, for example, the outer facade of a tall building and to rescue persons from the upper region of the building in case of, for example, a conflagration. This in particular when the drive motors provided on the climbing aid are strong enough to permit the transport of persons and preferably also are capable of operation under remote control. Thus, in the case of a tall building where the staircase is no longer passable, for example, the fire department can itself gain access to the upper stories and there safely transport persons downward on the climbing aid and/or safely reach the best possible location for firefighting.

Preferred embodiments of the arrangement or system according to the invention are characterized in dependent claims.

In what follows, the invention will be explained in greater detail in exemplary fashion and with reference to the appended drawings, in which:

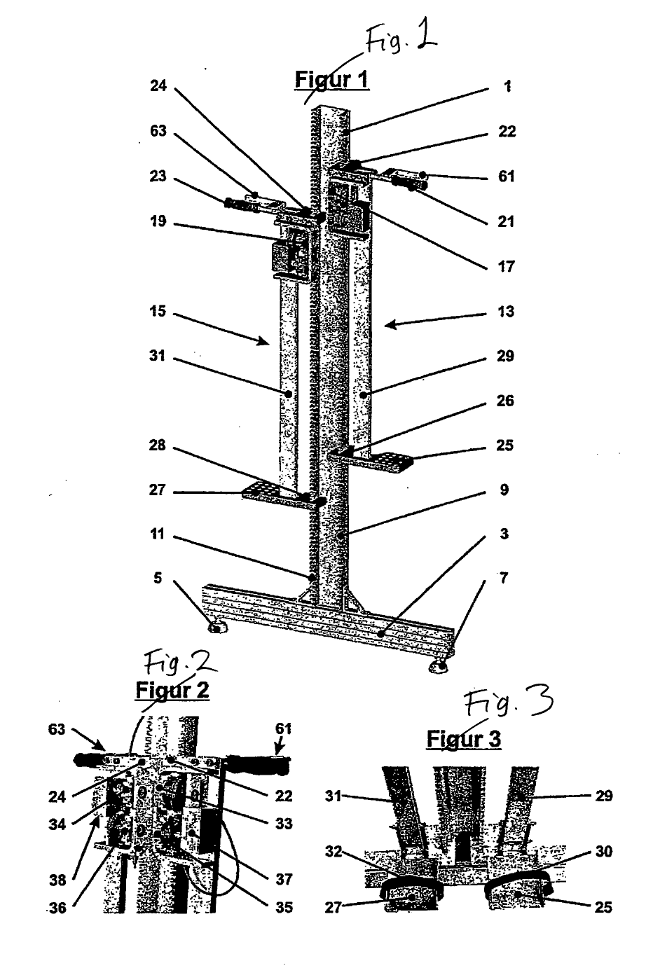

FIG. 1 depicts in perspective front view an arrangement according to the invention for the ascent or descent of one person;

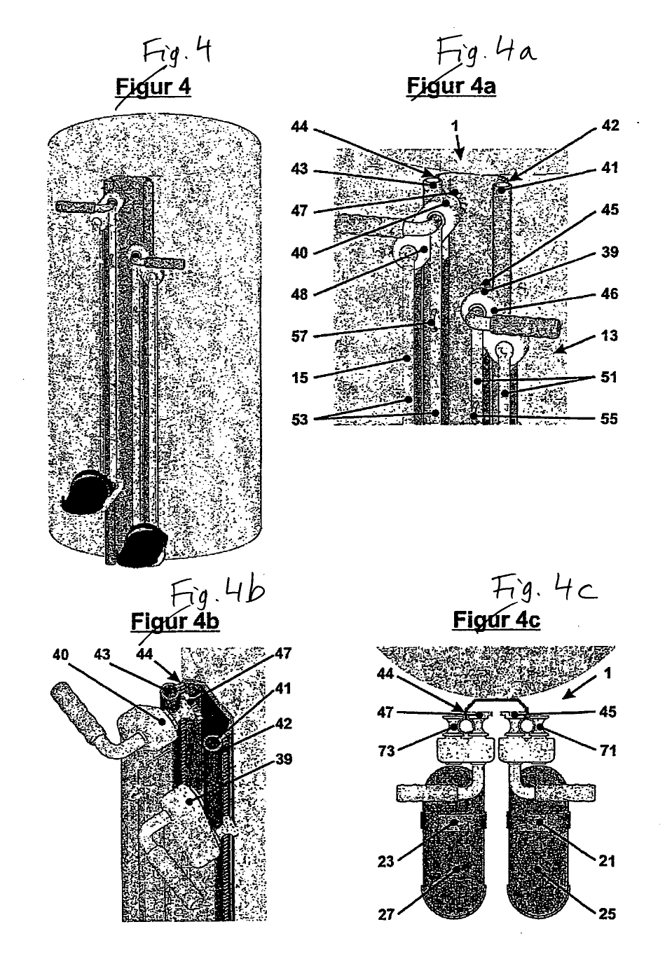

FIG. 2 depicts as a detail from FIG. 1 the guides of the climbing aids of the arrangement;

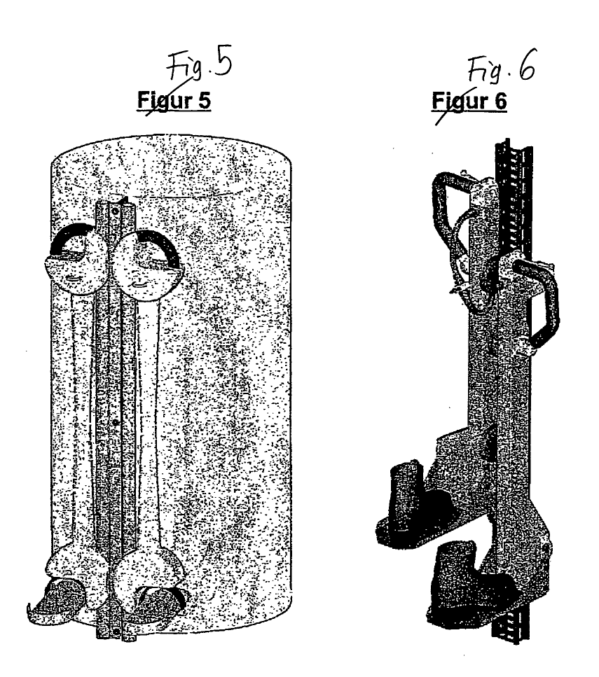

FIG. 3 depicts as a detail from FIG. 1 the platforms of the two climbing aids;

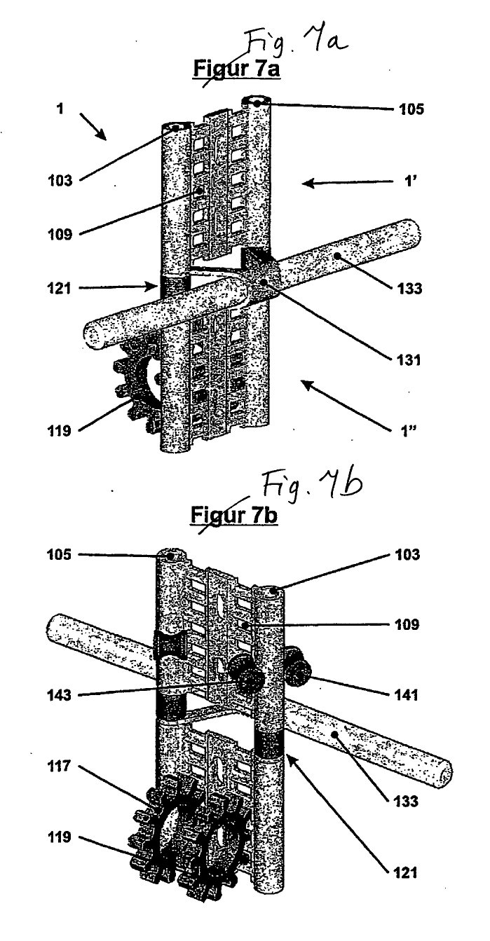

FIGS. 4 and 4a to 4c depict a further embodiment of an arrangement according to the invention;

FIG. 5 again depicts a further embodiment;

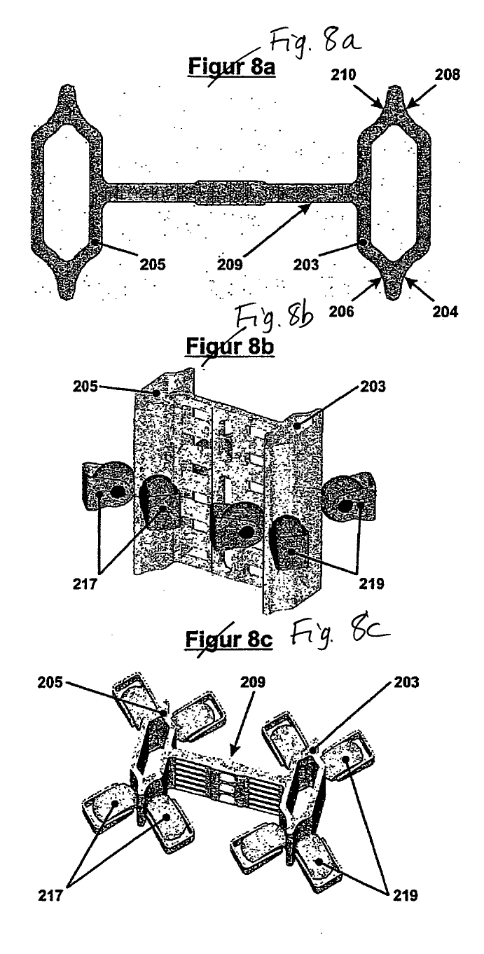

FIG. 6 once again depicts a further embodiment of an arrangement according to the invention;

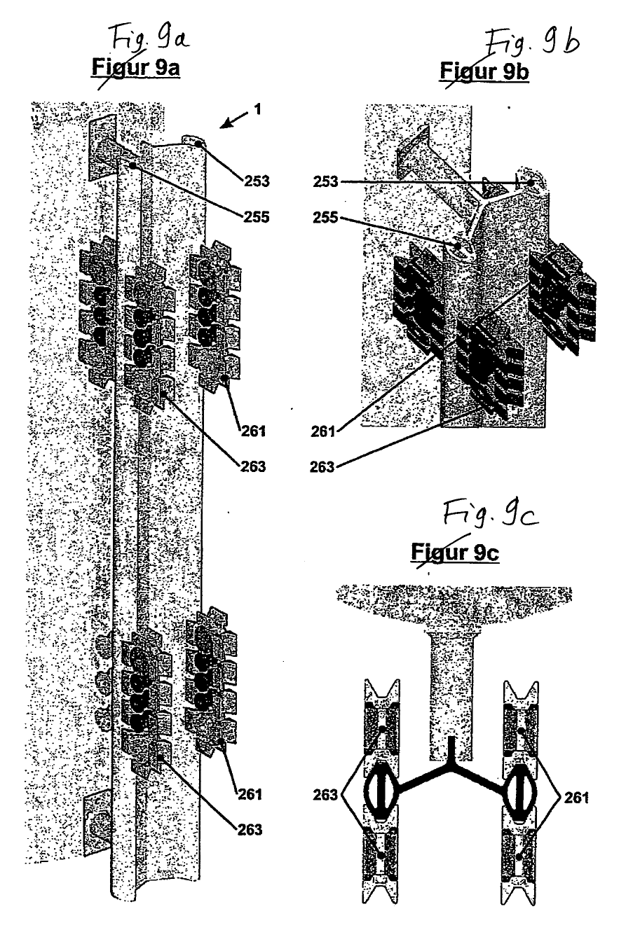

FIGS. 7a-b again depict the connection region of two rail-like profile elements, further showing holding elements for holding the force-transmitting pinions in the rail profile and further displaying a safety bar;

FIGS. 8a to 8c depict a further embodiment of a rail-like profile in cross section, in perspective and in top view with guide and force-transmitting elements arranged thereon;

FIGS. 9a to 9c again depict a further embodiment of a rail-like profile with force-transmitting elements arranged thereon;

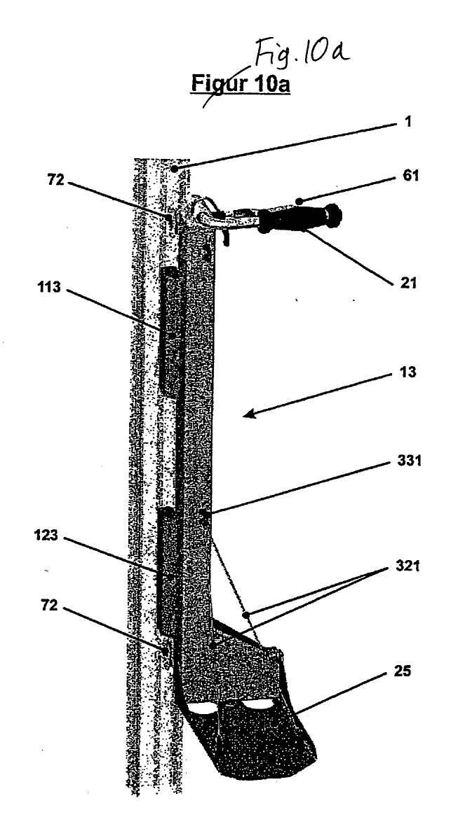

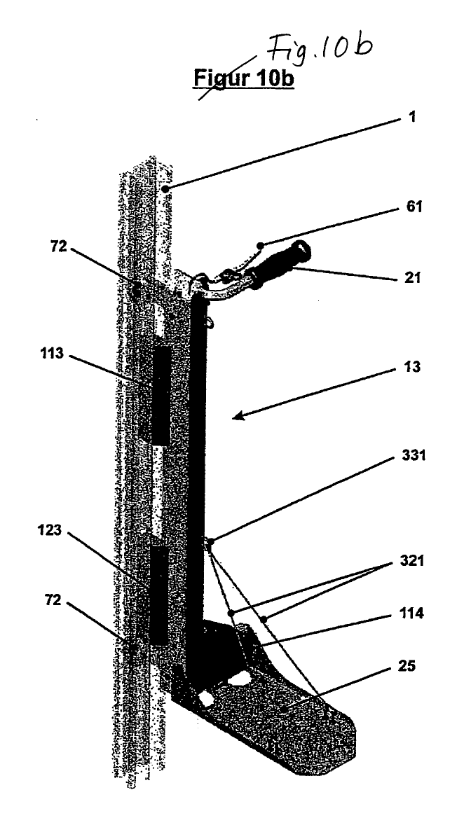

FIGS. 10a to 10c depict a further embodiment of a climbing aid according to the invention, showing a linear motor for driving the climbing aid;

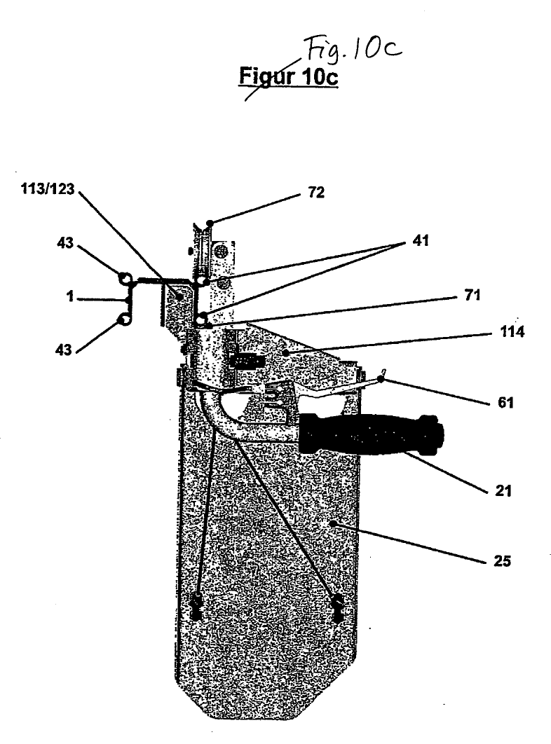

FIG. 11 depicts a further embodiment of a climbing aid according to the invention, showing drive motors for automatically driving the climbing aid upward;

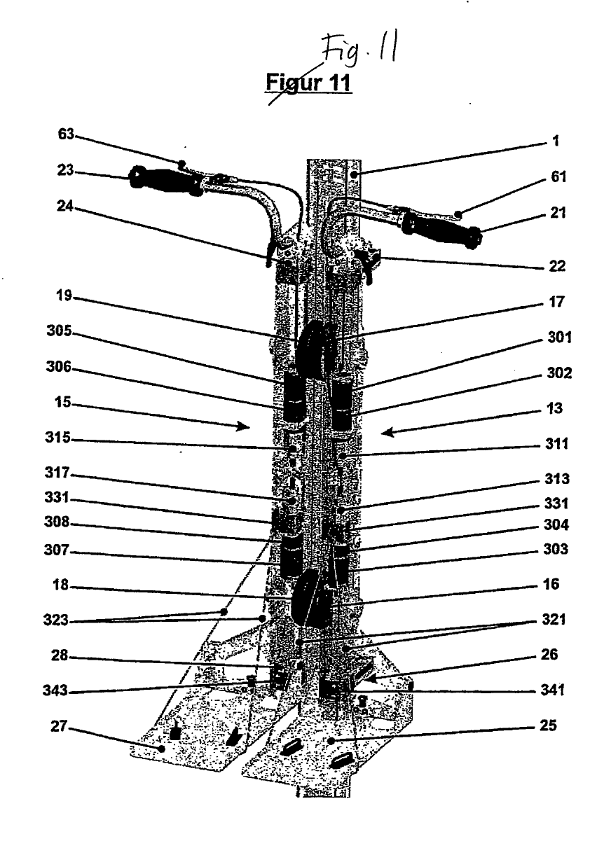

FIG. 12 depicts a possible use of the arrangement according to the invention for climbing a high-voltage pole;

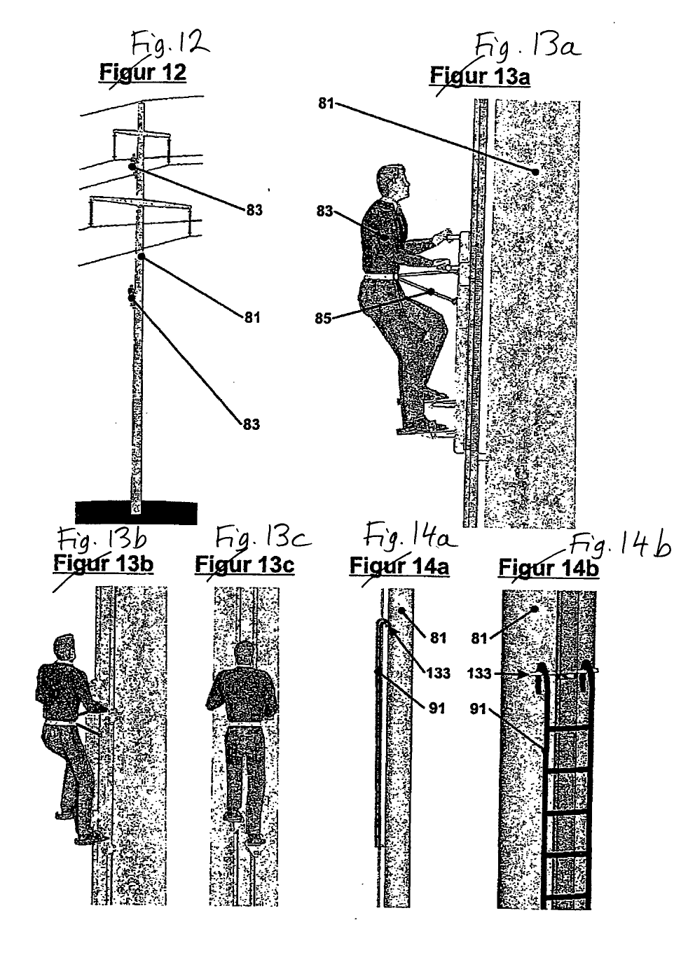

FIGS. 13a to 13c depict schematically, in lateral view, in lateral perspective and in rear view, the ascent of a person on a high-voltage pole; and

FIGS. 14a and 14b each depict a high-voltage pole in lateral view and in lateral perspective with an emergency ascent and descent ladder suspended on the rail-like profile.

FIG. 1 depicts schematically, in perspective, an arrangement according to the invention, essentially comprising a longitudinal extended rail-like profile 1 as well as the two climbing consoles 13 and 15 making possible the ascent and descent of a generally tall object.

Rail-like, longitudinally extended profile 1, which is for example U-shaped in cross section, has a gridwork 9 and 11 respectively on each of the two arms of the U. The profile itself, as stated at the outset, can be fixedly attached to the object to be climbed, as for example a high-voltage pole, or can be stood loose against the object in the manner of a ladder. A bearing arm 3 running transversely to rail-like profile 1 can be provided at the bottom end, which support arm is supported for example on height-adjustable feet 5 and 7.

The climbing aid comprises two climbing consoles 13 and 15, which each have pinion-like engaging elements or toothed rollers 17 and 19 respectively at the top for transmitting force, it being possible for there to be one, two or more pinions. Further there is a guide device 22 and 24 respectively in each case in order to hold the pinions or toothed rollers firmly in gridworks 9 and 11 respectively. Finally, the two climbing consoles each have at the top a handle 21 and 23 respectively having brake handles 61 and 63 onto which a person using the climbing aid can hold. At the bottom end of each of the two consoles is a platform 25 and 27 respectively on which the person can stand. Finally, also at the bottom end of the two consoles, there are guide devices 26 and 28 in order to hold the console on longitudinal profile 1.

The two top guides of the consoles are shown enlarged in FIG. 2. The two guides of consoles 13 and 15 each have two pinions 33 and 35 and respectively 34 and 36 rotatable in the longitudinal direction of the profile, which pinions are on the one hand each connected to a rotary dashpot 37 and 38, and which are each blockable, for example with a brake, in the downward direction of the profile. In the climbing direction or upward direction, however, the pinions are free to move or rotate.

As a rule, rotary dashpots contain rotating vaned wheels damped by an inert liquid, silicone oil as a rule, the liquid medium being forced through a throttle or slot. The braking torque is determined by the viscosity of the oil and the cross section of the throttle. In this way the torque of the rotary dashpot can be set individually.

FIG. 3 likewise shows a detail from the arrangement of FIG. 1, specifically the two platforms 25 and 27, but fashioned slightly differently. In addition, each of the two platforms 25 and 27 of FIG. 3 is provided with a foot strap 30 and 32, for example for the ascent of a person using the climbing aid. The person holds himself by the two handles 21 and 23. In order to ascend, the person now simultaneously raises the right hand on handle 21 and the foot standing on platform 25. The brake connected to pinion 36 of the left console prevents backward motion of console 15. In contrast, the two pinions 33 and 35 are free to rotate in the climbing direction, so that console 13 can easily be raised. After negotiating a certain climbing height, the ascending person repeats the same procedure with the left hand on handle 23 and the left foot on platform 27. Right console 13 is arrested by the automatically acting reverse-motion brake connected to pinion 33, so that slipping backward is rendered impossible.

When the person has attained the desired climbing height, for example has performed a repair operation to be carried out, descent is effected by actuating each of the brake levers 61 and 63 arranged on the two handles 21 and 23, for example by pulling. In this way, the two automatically acting brakes are released and the two consoles 13 and 15 move downward in controlled fashion, braked by the two rotary dashpots 37 and 38.

Instead of a rotary dashpot it is possible to use for example an eddy-current brake, a centrifugal brake, an electric motor, preferably driven as a generator, or another suitable mechanism to damp or retard the downward motion.

FIGS. 4, 4a, 4b, and 4c depict a further embodiment of an arrangement according to the invention, the three views 4a to 4c concentrating on the two guides 39 and 40 at the top ends of the consoles. FIG. 4a depicts the two guides in a front view of the rail-shaped profile; FIG. 4b is a perspective view; and FIG. 4c is a cross-sectional view of the two guides from above.

Again, rail-like profile-l is preferably U-shaped in cross section, tubular profiles 41 and 43 being fashioned on the ends of the two arms of the U, which tubular profiles serve as guide components. Grid-like force-transmitting positions 42 and 44 are arranged on each of the two arms of the U. The two consoles, each having two longitudinally fashioned bar-like connecting arms 51 and 53 on whose bottom ends the foot platforms (not illustrated) are in turn arranged, each have pinions 45 and 47 in guide units 39 and 40, which pinions engage in gridworks 42 and 44 respectively. With retaining rollers 71 and 73 arranged on both sides of each of tubular profiles 41 and 43, pinions 45 and 47 are held in the gridworks and disengagement of the pinions from the gridworks is prevented or rendered impossible.

FIG. 4b depicts the two top guide units 39 and 40 in lateral perspective as viewed from slightly above, the engagement of the two pinions in the gridworks being visible in particular.

FIG. 4c, finally, depicts a cross section as viewed from above, it being clearly visible how the two pinions 45 and 47 are held in gridworks 42 and 44 by retaining rollers 71 and 73.

Further embodiments of the arrangement according to the invention are illustrated in FIGS. 5 and 6, the representations in FIGS. 5 and 6 being intended more as so-called design studies. They are meant to show that the embodiments illustrated in FIGS. 1 to 4 can be arbitrarily modified or altered in the context of the invention.

As already stated in relation to FIGS. 4a to 4c, it is important that force-transmitting elements such as pinions 45 and 47 respectively are firmly held in gridworks 42 and 44 respectively of profile 1. For this reason, in FIG. 7b, the configuration of holding and guide rollers 141 and 143 respectively is schematically illustrated in perspective analogously to guide rollers 71 and 73 in FIG. 4c, which are guided on guide components 103 and 105 respectively. In this way, pinions 117 and 119 are firmly held in gridworks 109 of profile 1.

It can further be advantageous to arrange handle-like retaining or safety bars 133 at intervals along profile 1, as illustrated in FIG. 7a, in order to serve for example to secure the climbing aid or, however, for the suspension of, for example, additional ladders, as is explained in greater detail later on in relation to FIG. 13. Such retaining handles or bars 133 are preferably configured in the region of connections 121 of two profile pieces 1′ and 1″, as illustrated schematically in FIGS. 7a and 7b. These connecting elements 121 can be both elastic and rigid. It is additionally possible in the region of the connections to provide a retaining bracket 131 on which the retaining handle or retaining bar 133 just mentioned can be configured.

It is by no means necessary or mandatory that force must be transmitted from the climbing aid to the profile by pinions. It is entirely possible that force can be transmitted through wheels, rollers, or by a linear motor in contactless fashion, as schematically illustrated in FIGS. 8a to 8c, 9a to 9c, and 10a to 10c. Again there is a rail-like profile 1, as illustrated in section in FIG. 8a. To either side of a connecting web 209 there are two tubular profiles 203 and 205, each of which has longitudinally fashioned guide components 204, 206, 208, and 210 for guiding or for accommodating force from guide or drive rollers 219. For the sake of simplicity and greater clarity, the illustration of the climbing aid or consoles has been dispensed with, and only the drive or guide rollers 219 are schematically illustrated, in lateral perspective in FIG. 8b and in perspective as viewed from above in FIG. 8c. Because appropriate spring elements or other tension elements are present, rollers 219 are driven against guide components 204, 206, 208, and 210 so that adequate force is reliably transmitted both in ascent and in descent. Again, the rollers can be connected to reverse-motion brakes or rotary dashpots, etc., in order to make ascent or descent possible as described in detail in relation to FIGS. 1 to 4.

Instead of the rollers illustrated in FIGS. 8a to 8c, it is also possible to provide crawler-like force-transmitting elements as illustrated schematically in FIGS. 9a to 9c. Once again there is a longitudinally extended rail-like profile 1 with tubular profiles 253 and 255, each having an oval cross section, arranged on either side. Arranged engagingly onto these tubular profiles are crawler-like elements 261 and 263, one crawler preferably being arranged on either side of the tubular profile, as clearly visible in particular in FIG. 9c, in order in this way to ensure reliable force transmission and guidance.

The primary function of FIGS. 8a to 8c and 9a to 9c is to show that pinions or racks are not mandatorily to be used for transmitting force from the climbing aid to the rail-like profile. It is also entirely possible to provide rolls, wheels, crawlers, etc., for transmitting force.

FIGS. 10a to 10c further show schematically that linear motors can also be employed. Here force is transmitted in contactless fashion in that the driving is accomplished in known fashion by so-called electromagnetically controlled levitation. The linear motor generates a longitudinally moving magnetic field in order in this way to pull the consoles over the climbing distance to be traveled in each case. The way in which linear motors function, however, will not be gone into in greater depth here, because it is very well known from the literature.

FIG. 10a now depicts a climbing console that is held on a longitudinal profile 1 and has two linear motors 113 and 123. Guide rollers 71 and 72 hold console 13 to profile 1. In order to accommodate a person using the console, there is a platform 25 that is held to console 13 via support cable 321 to a lug 331.

FIG. 10b depicts the console of FIG. 10a in perspective in a slightly rotated position so that the two linear motors 113 and 123 can be seen better.

FIG. 10c finally depicts, in a sectional view from above, how console 13 is held to profile 1. It can be seen in particular how the console is held to tubular guide components 41 of profile 1 by guide rollers 71 and 72. The two linear motors 113 and 123, which cannot be seen, can be controlled, for example electronically, with a control 114, control taking place either automatically or by actuation of corresponding switch elements, for example on handle 21.

FIG. 11 depicts in perspective a further embodiment of an arrangement or climbing aid according to the invention. The representation is chosen analogously to that in FIG. 1 and, correspondingly, there are two climbing aids 13 and 15 with which ascent and descent along a rail-like profile 1, for example mounted on a high-voltage pole, are to be made possible. Again, force is transmitted at the top part of the two climbing aids via pinions 17 and 19 respectively, and additionally there are further pinions 16 and 18 in the bottom region of each of the climbing consoles. The two climbing aids are held to rail-like profile 1 by guide devices 22 and 24 respectively as well as 26 and 28 already-mentioned in relation to FIG. 1.

In contrast to the arrangements previously described, the two climbing aids 13 and 15 additionally have drive motors meant to support simplified ascent with the climbing aid according to the invention. Two motors 302 and 306 are provided for driving the two top pinions 17 and 19, each of which motors is connected via gears 301 and 305 to the respective pinions, for example via bevel gears. Analogously, the two bottom pinions 16 and 18 can, if required, each be driven by a drive motor 304 and 308, which motors are each connected to the pinions via speed-changing gears 303 and 307 as appropriate. Naturally, a direct drive without gears is also possible as appropriate.

Finally, brakes 311 and 313 as well as 315 and 317 are provided in the middle between the drive motors.

When a person ascends with the climbing aid according to the invention, the primary purpose of the drive motors is to drive the climbing aid upward in reinforced fashion without much resistance by automatically lifting the dead weight of the climbing aids during ascent.

If now a person standing on the two platforms 25 and 27 wishes to ascend along profile 1, he raises the foot, for example on the right side on platform 25, the two drive motors 302 and 304 being activated in this way as a result of unloading. This can be accomplished, first, via a contact or a switch in the region of the supporting brackets 341 and 343 respectively between climbing aids 13 and 15 respectively and platforms 25 and 27 respectively, or, however, by unloading of support cables 321 and 323 respectively, which are held to climbing aids 13 and 15 respectively by a support lug 331. Naturally, it is also possible to initiate driving, for example of the right climbing aid, by a corresponding switch on handle 21. Initiation of driving by electronic control is also possible.

Ascent is greatly simplified because the drive motors, such as for example battery-powered electric motors 302 and 304, drive at least the dead weight of the climbing aid upward. It is naturally possible to choose the driving force to be greater than that of the climbing aid, so that ascent becomes still simpler. The driving force can even be chosen such that the climbing aid according to the invention can be operated as a lift, so that persons can be conveyed upward or downward without any actuation of their own.

After the ascending person has negotiated a certain distance or the desired distance, he places his weight on platform 25, whereupon the upward motion of climbing aid 13 is interrupted. Now the foot is lifted off platform 27, so that the two drive motors 306 and 308 are activated and the left climbing aid is driven upward.

If the ascending person has now completed the ascent, the drive motors can be turned off, and descent takes place as described previously and by the preceding figures. It is additionally possible that the drive motors act as generators and current is recovered, for example in a battery such as a rechargeable battery pack or a so-called Supercap (SCAP). In this way it is possible that a plurality of ascents can be performed one after another with one and the same battery charge, without the batteries having to be recharged. The current loss per ascent is greatly reduced by the recovery, and the action range of the arrangement described according to the invention is much increased. The recovery may even be greater than the consumption.

A further advantage of the use of the drive motors or electric motors described according to the invention is that the arrangement or climbing aid according to the invention can be moved through remote control without a personal user. In other words, remote control is possible for both ascent and descent without payload.

It is further proposed that the speeds of the drive motors are controllable, so that the speed of both ascent and descent becomes controllable.

According to one embodiment it is proposed to use so-called linear motors, as described in relation to FIGS. 10a to 10c.

Finally, through the use of the drive motors mentioned, it is possible to equip or employ the arrangement or climbing aids according to the invention as a complete replacement for a person lift, as already stated previously. Employment as a person lift is also desirable in particular on the outer facades of tall buildings in that, for example, the fire department or other rescue teams can gain access to the upper region of a tall building even when the staircase or any elevators are no longer usable. In case of an outbreak of a conflagration, for example, the fire department can thus gain access to the upper region of the tall building, using the climbing aid, and rescue persons, that is, transport either persons to be rescued or injured persons downward with the climbing aid, the climbing aid being capable of remote control in this case. It is also possible, however, to arrange a rising pipe parallel to the profile so that the fire department, having climbed the building with a climbing aid, can connect hoses to the rising pipe in the upper region and thus begin the extinguishing process.

FIG. 12 depicts a possible application of the arrangements according to the invention on a high-voltage pole. The longitudinally extended rail profile is arranged along the entire pole 81, and a person climbing the high-voltage pole can ascend along the rail profile, using the climbing aid. Here, as depicted in FIG. 12, it is possible that for example two or more persons can climb up the pole with climbing aids defined according to the invention.

FIGS. 13a to 13c, being details from FIG. 12, depict the position on high-voltage pole 81 where one of the two climbing persons illustrated in FIG. 12 is located. Here FIG. 13a is a view from the side, 13b is a perspective view, and 13c is a view of the person from behind. In addition to the preceding figures, a further safety device such as a safety belt 85 is illustrated in FIGS. 13a to 13c. This can be fastened for example to the consoles, as at fastening lugs 55 and 57 respectively, as illustrated in FIG. 4a. Further, it is also possible to connect the two fastening lugs 55 and 57 to each other, for example with a belt, so that for example if the brake on one console fails, this is held by the other console via the connecting belt.

Finally, FIG. 14 depicts schematically the possibility of employing a safety ladder 91, which can be suspended in or on retaining bars 133, as illustrated in FIGS. 7a and 7b. If for example a high-voltage pole 81 must be climbed without the presence of climbing aids, climbing with hand ladders 91 is still possible in that a ladder can be suspended in each case as in FIG. 14a or 14b and a further ladder can be pulled up from below. This further ladder can then be suspended or secured on retaining bars 133, which are mounted to the rail-like profile above the ladder arranged in FIGS. 14a and 14b.

The arrangements or embodiments of the climbing aids and rail-like profile as illustrated in FIGS. 1 to 14 are of course only examples, which can be altered, supplemented, or modified in arbitrary fashion. The application illustrated in relation to FIGS. 12 and 13 depicts only one possible example, and the arrangement proposed according to the invention can naturally be employed on other objects, such as for example cableway masts, silos, building walls, in shafts, etc. It is also possible to arrange such an arrangement on a building wall as a fire ladder, which fire ladder can serve both for the downward rescue of persons and for the ascent of firefighters upward. In the rescue area, in particular, it is also entirely possible and desirable to provide climbing aids or consoles that are suitable only for the descent or rescue of persons, for example from a high-rise building. In this case the climbing aid is preferably fashioned in one piece, which is in turn connected via force-transmitting elements to a rail-like profile and to a brake, and also to a rotary dashpot or an electric motor brake or linear motor brake. In the case of employment on high-rise buildings, the climbing aid can preferably be operated as a lift under remote control. This can, however, also be desirable or necessary in certain cases of employment on high-voltage poles, cableway masts, etc.

It is possible, finally, to arrange a rail-like profile fixedly to an object, or, however, the rail-like profile can be stood loose against an object in the manner of a ladder.

1. An arrangement for the ascent and/or descent of one or a plurality of persons on an object, characterized by at least one longitudinally extended rail-like profile (1, 1′, 1″) having at least one guide component (41, 43, 103, 105, 204, 206, 208, 210, 253, 255) extending along the profile and a component for the accommodation of force transmission (9, 11, 42, 44, 109) onto the profile and/or guide component, and by a climbing aid having at least one climbing console (13, 15) having at least one platform or seat (25, 27) as well as a personal safety device and/or a handle (21, 23), as well as at least one force-transmitting element (17, 19, 45, 47, 117, 119, 217, 219, 261, 263) engaging in or on the force-transmitting component and/or profile and/or a drive (113, 123, 302, 306),as well as a device (22, 24, 71, 72, 73, 141, 143) holding the element or drive in or on the at least one guide component and/or profile.

2. The arrangement according to claim 1, characterized in that the at least one guide component and/or the force-transmitting component is formed by at least one rack-like or grid-like longitudinal guide.

3. The arrangement according to one of claims 1 or 2, characterized in that the climbing aid has at least one climbing console (13, 15), preferably two, having at least one force-transmitting element and/or drive, as well as at least one holding device for holding the force-transmitting element or drive in or on the guide component and/or force-transmitting component.

4. The arrangement according to one of claims 1 to 3, characterized in that the at least one rotating force-transmitting element engaging in or on the longitudinal guide component(s) and/or the force-transmitting component is a pinion.

5. The arrangement according to one of claims 1 to 4, characterized in that the climbing console is longitudinally extended with a handle arranged at the top end in the direction of ascent and a platform arranged at the downward end.

6. The arrangement according to one of claims 1 to 5, characterized in that the force-transmitting element engaging in or on the at least one guide component and/or force-transmitting component or the drive is blockable at least in the downward direction and preferably remains free to rotate or slide in the direction of ascent.

7. The arrangement according to one of claims 1 to 6, characterized in that the element engaging in or on the at least one guide component and/or force-transmitting component or the drive is damped and/or operatively connected to another suitable motion-damping or motion-inhibiting means, such as an eddy-current brake, centrifugal brake, or linear brake system, that is, that free mobility of the respective climbing console is not possible in the downward direction or the direction downward.

8. The arrangement according to one of claims 1 to 7, characterized in that means for releasing brakes (61, 63) are arranged in the region of the handles for the actuation of the downward unblocking of the force-transmitting element or drive, in order to make possible a damped downward motion of the climbing console or climbing consoles with simultaneous activation of the rotation or damping elements.

9. The arrangement according to one of claims 1 to 8, characterized in that a retaining apparatus, such as for example a safety belt or harness (85), is arranged on at least one of the at least two climbing consoles for securing the person using the climbing aid.

10. The arrangement according to one of claims 1 to 9, characterized in that the longitudinally extended rail-like profile is fastenable to an object or loosely mobile.

11. The arrangement according to one of claims 1 to 10, characterized in that at least one force-transmitting element is both blockable with brakes and also rotationally or linearly damped.

12. The arrangement according to one of claims 1 to 11, characterized in that along the longitudinally extended profile and at least approximately transversely to the longitudinal extension of the profile there are arranged retaining bars provided, for example, for the suspension of auxiliary ladders.

13. The arrangement according to one of claims 1 to 12, characterized in that the force-transmitting elements are provided with a drive, such as for example an electric motor, an internal combustion engine, a linear motor, etc.

14. The arrangement according to one of claims 1 to 13, characterized in that the force-transmitting elements are each connected to a drive motor, via gears as appropriate, in such fashion that each drive motor is provided in order to drive preferably at least the dead weight of the climbing console in question or of the arrangement as a whole upward upon activation.

15. The arrangement according to one of claims 13 or 14, characterized in that the drive motor is actuatably operatively connected to the platform, the seat, and/or the handle so that the drive motor can be activated or deactivated for example by unloading the platform or seat or by actuation of the handle or by electronic control.

16. The arrangement according to one of claims 13 to 15, characterized in that the drive motor is additionally equipped as a generator in order to recover current during downward movement of the arrangement in order to feed for example a battery or rechargeable battery pack or a so-called Supercap (SCAP).

17. A method for the ascent and/or descent of a person on an object using an arrangement according to one of claims 1 to 16, characterized in that the person can ascend and/or descend along a longitudinally extended rail-like profile on the object using a climbing aid in such fashion that the climbing aid is provided with force-transmitting elements engaging in or on the rail-like profile and/or a drive, the person being able to unblock the force-transmitting elements or drive while descending, and descent taking place in damped fashion by connecting the force-transmitting elements or the drive to a rotary dashpot, an-eddy current brake, centrifugal brake, linear motor or the like.

18. The method according to claim 17, characterized in that the climbing aid is fashioned in two parts and the person using the climbing aid first ascends using one console by rendering the force-transmitting elements or the drive free in the climbing direction while blocking the force-transmitting elements on the other console in order to prevent downward sliding of the other console; and that, after negotiating a certain climbing height, the person ascends with the other console by blocking the force-transmitting elements or the drive on the one console.

19. The method according to one of claims 17 or 18, characterized in that for the descent of a person using the climbing aid, the blocking of the force-transmitting elements or drive is unblocked and descent takes place in controlled or damped fashion.

20. A method for the ascent and/or descent of a person on an object using an arrangement according to one of claims 1 to 16, characterized in that the person can ascend and/or descend along a longitudinally extended rail-like profile on the object using a climbing aid in such fashion that by actuating a drive motor on either of the two consoles of the climbing aid, this drive motor drives at least the dead weight of the respective climbing aid negotiatingly upward, actuation being able to take place either automatically by unloading of the respective platform or seat or, however, by actuation of a corresponding control on the respective handle, and that after the negotiation of a certain climbing height, the drive motor is deactivated and the drive motor on the other climbing aid is activated, for example automatically, in order to drive the other climbing aid correspondingly upward.

21. The method according to claim 20, characterized in that the drive motors are activated or deactivated automatically in that, for example on unloading of the platform or seat, the respective drive motor, such as for example a battery-driven electric motor, is activated while the other drive motor remains deactivated automatically by loading of the platform or seat or under electronic control.

22. The method according to one of claims 20 or 21, characterized in that in the descent of a person using the arrangement according to the invention, the drive motors are operated in the manner of generators for generating current and for example a battery, such as for example a rechargeable battery pack or a Supercap (CAP), can be fed with the current generated.

23. The use of the arrangement according to one of claims 1 to 16 for the climbing of high-voltage poles, cableway masts, silos, building walls, shaft walls, etc.

24. The use of the arrangement according to one of claims 1 to 16 as a rescue device or as a fire ladder in the case of tall buildings.

25. The use of the arrangement according to one of claims 1 to 16 as a self-contained person lift.

26. A rail-like profile (1, 1′, 1″) for an arrangement according to one of claims 1 to 16, characterized by at least one guide component (41, 43, 103, 105, 204, 206, 208, 210, 253, 255) extending along-the profile as well as a component (9, 11, 42, 44, 109) for accepting force transmission onto the profile and/or guide component.

27. The rail-like profile according to claim 26, characterized in that the at least one guide component and/or the force-transmitting component is formed by at least one rack-like or grid-like longitudinal guide.

28. The use of the rail-like profile according to one of claims 26 or 27 as guide for a climbing aid on an outer facade of a high-rise building, on a high-voltage pole, on a cableway mast, on silos, on shaft walls, etc.

29. The use of the rail-like profile according to one of claims 26 or 27 for the guidance of rescue devices on tall buildings.
